(19) United States
(12) Patent Application Publication
(10) Pub. No.: US 2015/0298619 A1
(43) Pub. Date: Oct. 22, 2015

(54) PURSE PERCH

(71) Applicant: Carol Parisi, Mt. Laurel, NJ (US)

(72) Inventor: Carol Parisi, Mt. Laurel, NJ (US)

(21) Appl. No.: 14/257,080

(22) Filed: Apr. 21, 2014

(51) Int. Cl. B60R 11/00

(52) U.S. Cl. CPC B60R 11/00; B60R 2011/0015

(57) ABSTRACT

An apparatus for attaching a purse or other carrying bag to the seat of an automobile is disclosed. The apparatus includes an upper strap of adjustable length by means of a buckle. The upper strap is adapted to attach the apparatus to the head rest of an automobile seat. The upper strap is attached to a second strap. The purse attachment devices are fixed to the second strap. The strap or buckles on a purse are attached to the attachment devices so that the purse will be readily accessible to a driver or passenger in the automobile.

### BACKGROUND OF THE INVENTION

The present invention is directed to the field of securing items in an automobile during transit. In particular, the present invention is directed to an apparatus that can be attached to an automobile seat to secure a purse or other bag while providing easy access to the purse by the driver or passenger.

### SUMMARY OF THE INVENTION

1. An apparatus for securing a purse or other carrying bag to a seat in an automobile so that the purse or bag is readily accessible by a driver or passenger comprising, an upper strap of adjustable length that secures the apparatus to the seat, a lower strap attached to the upper strap adapted to be placed over the side of the seat, and attachment devices connected to the lower strap wherein the attachment devices receive a strap or buckle on the purse and secure the purse therein.

### BRIEF DESCRIPTION OF THE DRAWINGS

FIG. 1 is an isometric view illustrating the attachment of the present invention to an automobile seat head rest.

FIG. 2 illustrates a front plan view of the present invention.

FIG. 3 illustrates a rear plan view of the present invention.

FIG. 4 illustrates a side plan view of the present invention.

FIG. 5 illustrates a side plan view of the present invention.

FIG. 6 illustrates a top plan view of the present invention.

FIG. 7 illustrates a bottom plan view of the present invention.

### DETAILED DESCRIPTION OF THE INVENTION

The present invention will now be described in terms of the presently preferred embodiment thereof as illustrated in the drawings. Those of ordinary skill in the art will recognize that many obvious modifications may be made thereto without departing from the spirit or scope of the present invention.

The Purse Perch 10 of the present invention is illustrated in the drawings. The Purse Perch 10 comprises a lower strap 11. Two purse attachment devices 12 are attached to the lower strap 11 by means of loops 14 in this embodiment, The purse attachment devices 12 in this embodiment comprise a loop 13 with a spring-loaded arm 15. The spring loaded arm 15 can open and close by rotating about pivot point 17. The Purse Perch 10 further comprises an upper strap 16 of approximately 18 inches in length. The length of the upper strap 16 can be adjusted by means of a conventional buckle 18. The upper and lower straps 11 and 16 are contemplated to be fabricated from nylon but other equivalent materials with similar strength characteristics can be substituted for nylon.

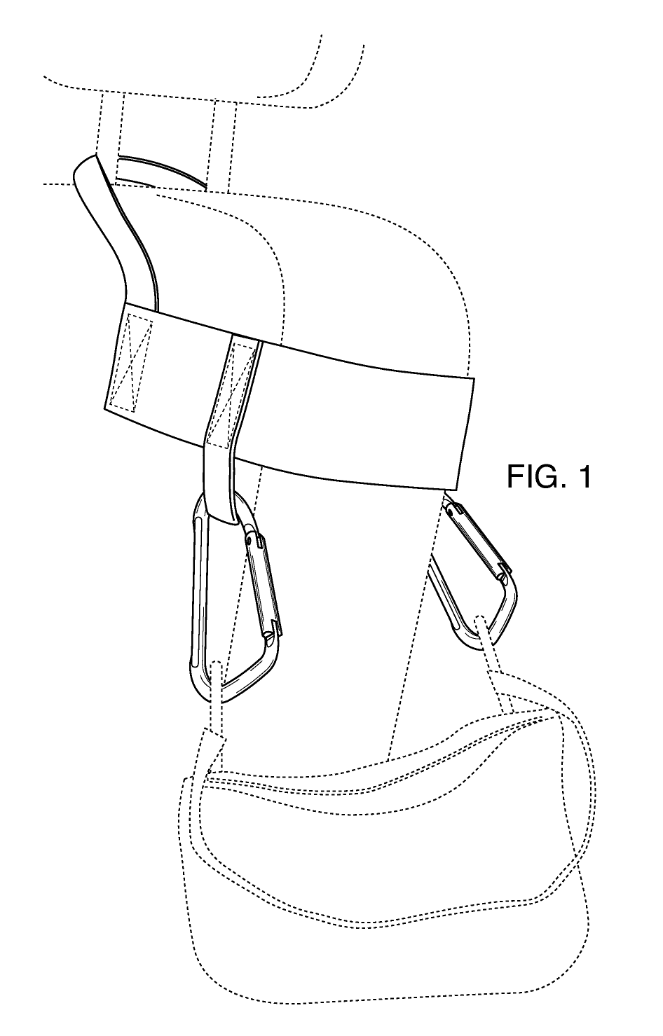

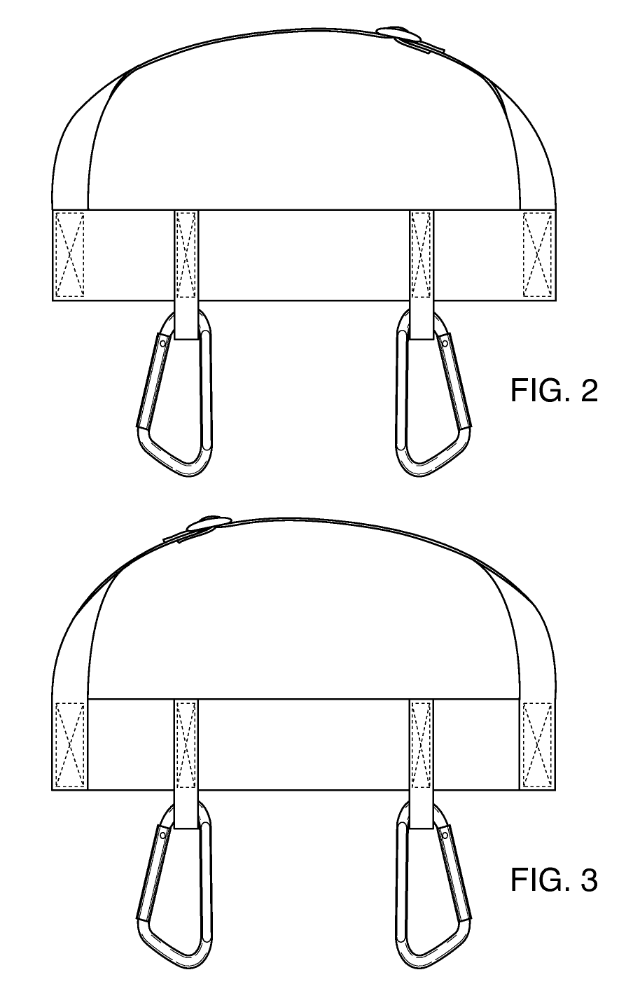

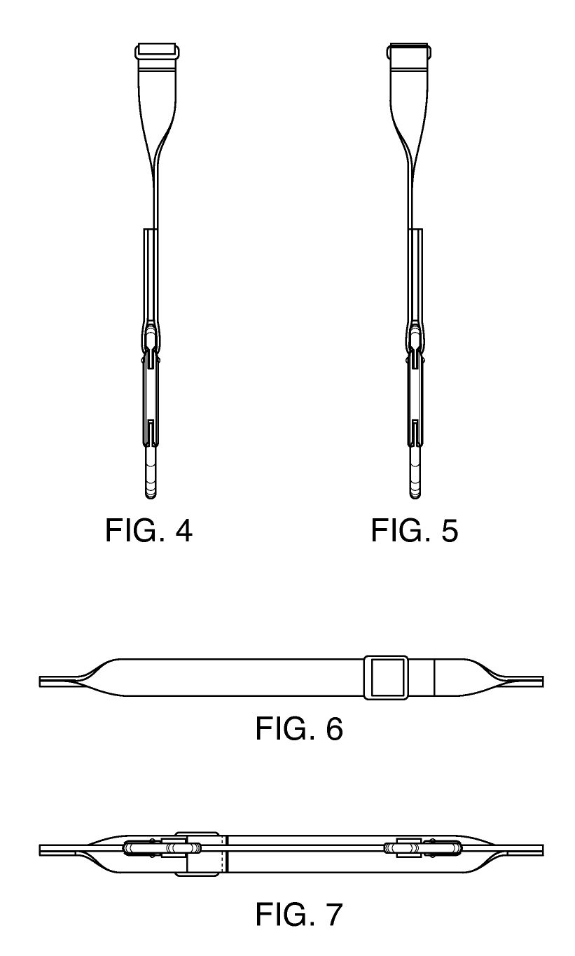

In practice, the Purse Perch 10 will be attached to the side of the passenger seat near the driver. The upper strap 16 will be placed around the base of the passenger seat head rest as shown in FIG. 1. The length of the upper strap 16 is adjusted by means of the buckle 18 to create a relatively secure fit and to allow for length adjustment depending upon the size of the purse to be attached. The first strap 10 will be placed over the side of the passenger seat closest to the driver. The strap or buckles on the purse will be attached to the purse attachment devices 12 by opening the spring-loaded arm 15 and inserting the strap or buckles into the loop 13. In this way, the purse will be easily accessible to the driver of the vehicle.

Those of ordinary skill in the art will recognize that the foregoing merely represents an embodiment of the present invention. Many obvious modifications may be made thereto without departing from the spirit or scope of the present invention as set forth in the applied application.

What is claimed is:

1. An apparatus for securing a purse or other carrying bag to a seat in an automobile so that the purse or bag is readily accessible by a driver or passenger comprising:
a. an upper strap of adjustable length that secures the apparatus to the seat:
b. a lower strap attached to the upper strap adapted to be placed over the side of the seat; and
c. attachment devices connected to the lower strap;
Wherein the attachment devices receive a strap or buckle on the purse and secure the purse therein.

2. The apparatus of clam 1 wherein the attachment device comprise a loop with a spring-loaded arm wherein the strap or buckles are received in the loop.
